(19) United States
(12) Patent Application Publication
(10) Pub. No.: US 2002/0093427 A1
(43) Pub. Date: Jul. 18, 2002

(54) Pharmaceutical container which transmits an audio signal

(76) Inventors: Joseph D. Roth, Springboro, OH (US); John C. Rosenbaum, Springboro, OH (US)

Correspondence Address: Douglas S. Foote, NCR Corporation, 101 West Schantz, ECD-2, Dayton, OH, 45479-0001, US

(21) Appl. No.: 09/761,650

(22) Filed: Jan. 18, 2001

(51) Int. Cl. G08B 23/00

(52) U.S. Cl. 340/573.1; 340/540

(57) ABSTRACT

A pharmaceutical container which generates audio signals that contain information regarding the dosage of the pharmaceutical in the container. In preferred embodiments, the container comprises a switch, a micro-electronic device with programmable memory cells for storing dosage information, a sound device and an electric power source. It is preferable that the dosage information be stored in the programmable memory cells either simultaneously or contemporaneously with the printing of dosage information on a label for the container.

### FIELD OF THE INVENTION

The present invention is directed to pharmaceutical containers which provide dosage information in the form of an audio signal.

### BACKGROUND OF THE INVENTION

Many efforts have been made to prevent the incorrect administration of drugs and other pharmaceuticals. The pharmaceutical industry has gone through great lengths to educate patients and improve the understanding of prescribed medications and the means for their administration. In addition to providing dosage information on pill bottles, supplemental information such as flyers as well as verbal instructions from a pharmacist are typically offered at the time of dispensing the pharmaceutical to the patient. Despite the efforts made at the time of dispensing the pharmaceutical, memories can be faulty or confused, the flyers lost and the print on the bottle can be difficult to read. Medication dispensers and monitors such as those described in U.S. Pat. No. 5,582,323 are helpful in achieving the proper administration of pharmaceuticals but are cumbersome and typically must be filled and/or programmed either by the patient, nurse or other health care provider after they are dispensed by the pharmacist, which can lead to errors. It is desirable to provide an additional means for instructing as well as monitoring the administration of pharmaceuticals after they are dispensed by a pharmacist. In addition, it is desirable to prepare such supplemental information at the same time the dosage label is prepared for a pharmaceutical so as to avoid inconsistencies.

At present, forms with integrated labels are used in preparing the dosage instructions for pharmaceuticals. These forms allow for the simultaneous printing of labels for containers such as pill bottles and flyers which contain identical and/or complementary information to that which appears on the labels. Simultaneous printing of the labels and flyers limits errors and inconsistent dosages and allows the dosage information on the bottle to be supplemented and reinforced. It is desirable to supplement and reinforce this information even further.

Micro-electronic devices which produce sounds and synthesized speech are well known and their incorporation in various articles such as greeting cards, picture frames and beverage cans are known. Examples of such devices are described in U.S. Pat. Nos. 4,791,741; 5,063,698; 5,115,422; 5,130,696; 5,359,374 and 5,973,250.

### SUMMARY OF THE INVENTION

The present invention provides a pharmaceutical container which generates an audio signal that provides information regarding the dosage of the pharmaceutical in the container. In preferred embodiments, the audio signal reinforces or supplements the written instructions on the label of the pharmaceutical container by providing information consistent with the dosage or other written instructions on the label.

The container includes a micro-electronic device capable of sending an audio signal with information regarding the dosage or other written instructions printed on the label. The audio signal can include verbal information or audible tones. The verbal information can include what the medication is, when to take it, what to take with it, what not to take with it, contra-indications, and other information including that unrelated to the medication such as emergency phone numbers and advertisements. The audible tones can be a single note or a tune that functions as a warning or a series of tones that will dial a specific phone number. This information can be repeated without having to be read off the label and is advantageous for the vision impaired, elderly, or literacy impaired populations. The audio signal allows the dosage information printed on the label or other information to be readily reviewed by activation of the micro-electronic device either actively or passively such as by opening the container. The micro-electronic device is programmable to provide information either general or specific to the dosage instructions. Preferably, the micro-electronic device is programmed simultaneously or contemporaneously with the printing of the label for the pharmaceutical container. The micro-electronic device can be incorporated in or on the walls, bottom or top (cap) of the container or a label for the container. For example, in the case of a pill bottle, the micro-electronic device can be molded in the cap, walls or the bottom portion of the bottle, adhered to the cap, walls or bottom portion of the bottle with an adhesive or retained within a cavity in the cap, bottom portion or walls of the bottle.

### BRIEF DESCRIPTION OF THE DRAWINGS

FIG. 1 is a cross-sectional view of a pill bottle with a micro-electronic device within its cap, consistent with the present invention.

FIG. 2 is a cross-sectional view of a pill bottle consistent with the present invention having a micro-electronic device molded into its base.

FIG. 3 is a cross-sectional view of a pill bottle consistent with the present invention having a micro-electronic adhered to its side.

FIG. 4 is an exploded view of the cap of a pill bottle which contains a micro-electronic device therein.

FIG. 5 is a perspective view of a pharmaceutical container consistent with the present invention which retains medications in a blister pack.

FIG. 6 is a perspective view of a pharmaceutical container of FIG. 5 with the blister pack disposed therein.

FIG. 7 is a perspective view of a pharmaceutical container of FIG. 5 which is closed.

FIG. 8 is a diagram of a micro-electronic device used in the pharmaceutical containers, of the present invention.

FIG. 9 is a schematic representation of an audio signal generator circuit used in the micro-electronic device of the present invention.

FIG. 10 is a schematic representation of another audio signal generator circuit used in a micro-electronic device of this invention.

### DETAILED DESCRIPTION OF SELECTED EMBODIMENTS

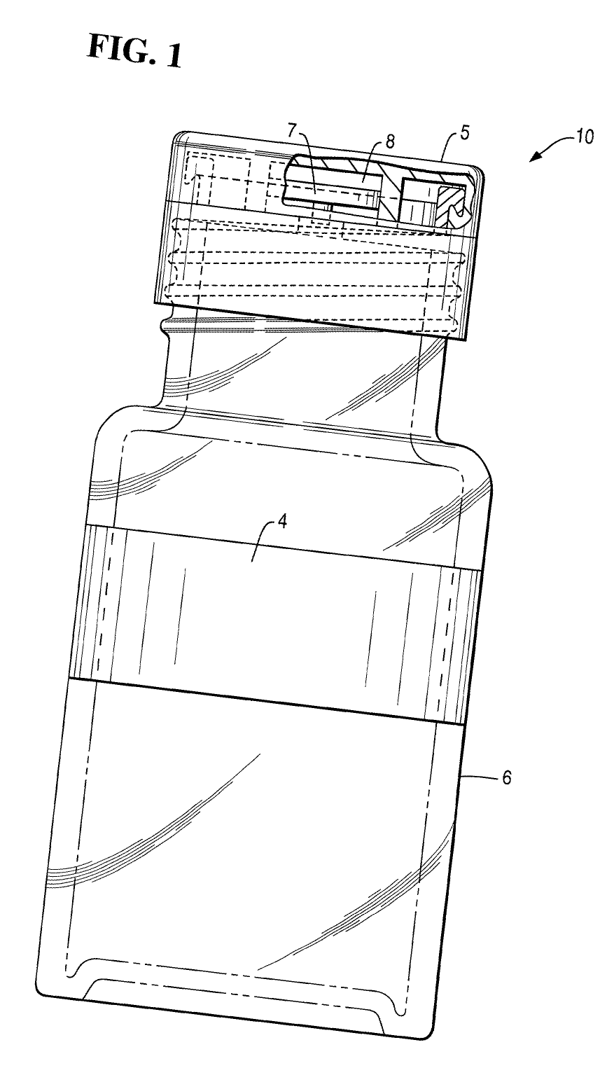

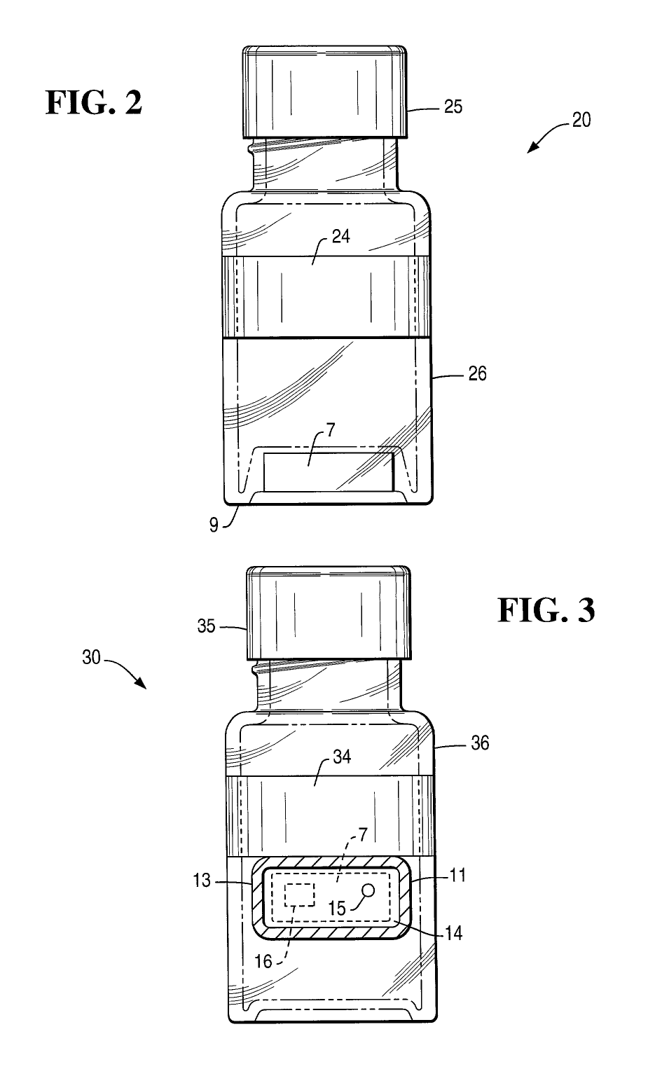

FIG. 1 illustrates a pill bottle 10 with a label 4, cap 5 and base 6. Cap 5 has a micro-electronic device 7 incorporated in a cavity 8. FIG. 2 illustrates a pill bottle 20 with label 24, cap 25 and base 26 where micro-electronic device 7 is molded into bottom 9 of base 26. FIG. 3 illustrates a pill bottle 30 with a label 34, cap 35 and base 36 where micro-electronic device 7 is adhered to the side of base 36 as part of a label laminate 11 which comprises adhesive lined base sheet 13 and a top sheet 14 which encapsulate the micro-electronic device 7, allowing piezoelectric sounding device 15 to be exposed through top sheet 14. Switch 16 protrudes under the surface of top sheet 14. It is contemplated that micro-electronic device 7 can be molded in, adhered to or incorporated in any component of a pharmaceutical container.

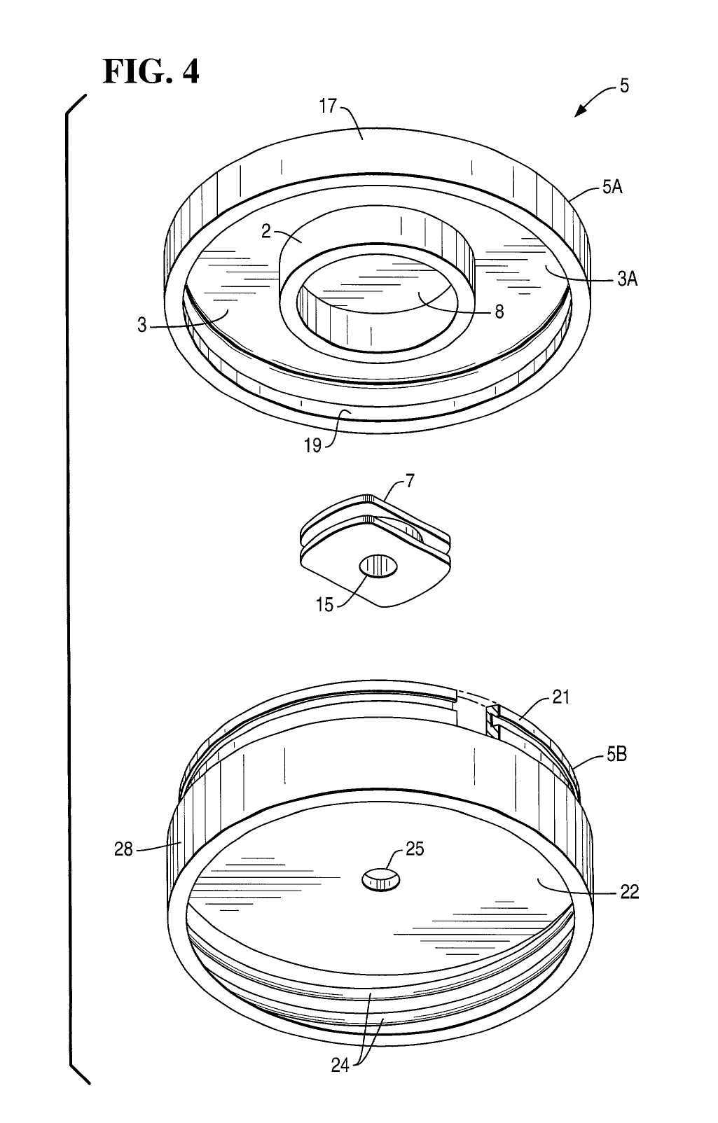

FIG. 4 illustrates pill bottle cap 5 having two sections, 5a and 5b. Cavity 8 is formed in section 5a by circular wall 2 on the inner surface 3a of base 3. Rim 17 extends from the edge of base 3 and terminates with locking edge 19 to interlock with section 5b via locking edge 21. Section 5b has wall 28 which extends from the edge of base 22. Wall 28 has threads 24 which corresponds to the threads on a pill bottle base (not shown). Base 22 retains the micro-electronic device 7 in cavity 8 and provides a hole 25 to expose the piezoelectric sounding device 15.

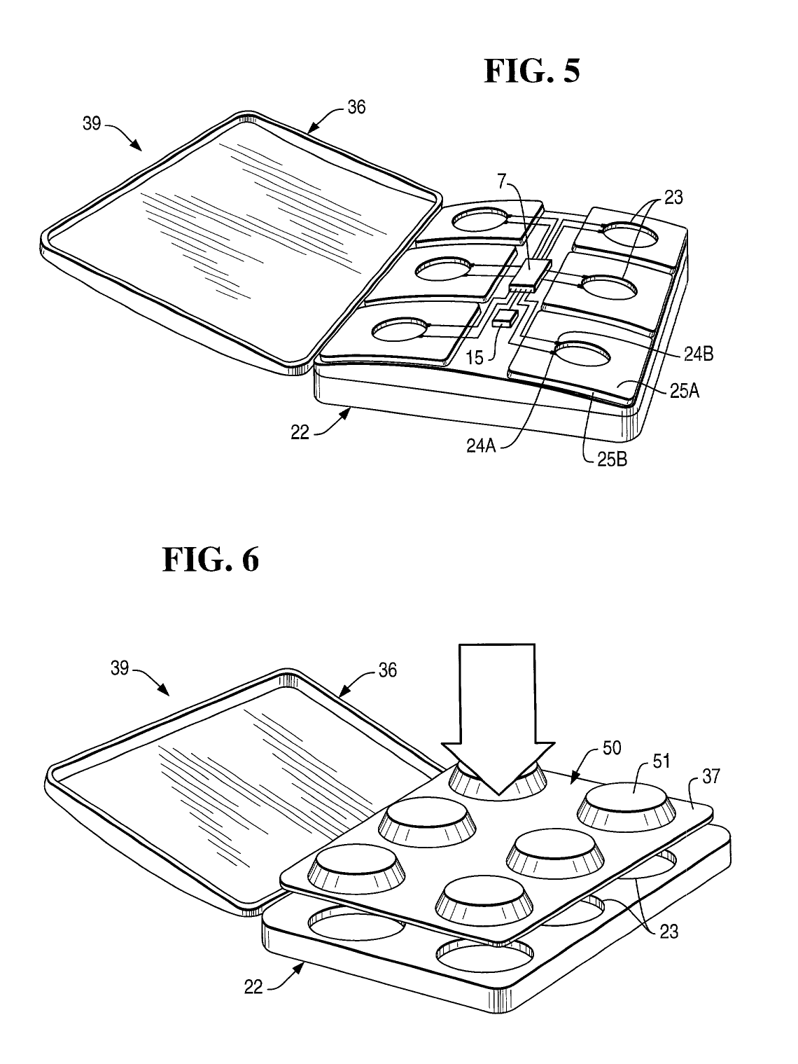

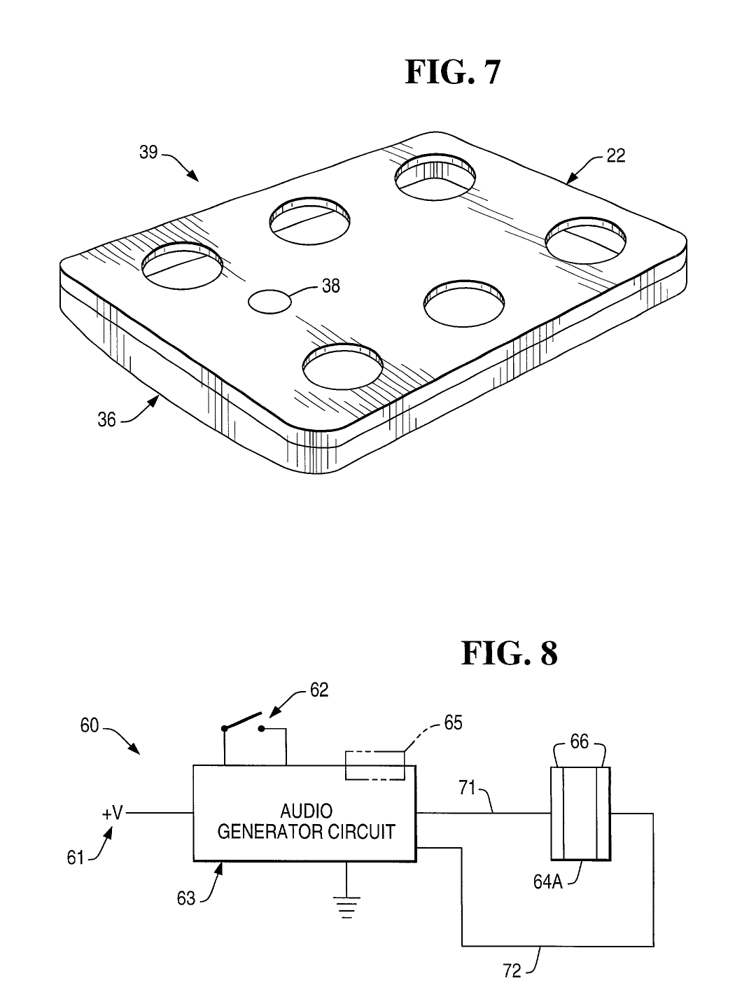

FIG. 5 illustrates an alternative to a pill bottle which permits monitoring of the medications taken. Case 39 contains a base 22 and cover 36. Base 22 has holes 23 with pairs of leads 25a and 25b connected to micro-electronic device 7. One of each pair of leads 25a and 25b terminates with contacts 24a and 24b in one of holes 23. Case 39 is configured to retain a blister pack 50 of medications with foil back 37 shown in FIG. 6. Holes 23 are configured to be aligned with pills 51 in blister pack 50. Moving the pills from the blister pack 50 by pushing through holes 23 perforates foil backing 37, which now touches contacts 24a and 24b. This closes a circuit for a pair of leads of 25a and 25b, signaling to microcircuit 7 that a medication has been removed from container 39. Hole 38 in base 22 permits audio signals from piezoelectric sounding device 15 to transmit out of the container 39 when closed as shown in FIG. 7. This configuration can be varied widely. For example, removing the pill can break a closed circuit to signal microcircuit 7.

The micro-electronic device employed in the pharmaceutical container of the present invention preferably comprises a switch for activation of the micro-electronic device, an audio signal generating circuit, a sound device which generates sound waves and an electric power source.

The switch serves to activate the micro-electronic device to transmit an audio signal. This switch which can be those which are manually activated by the patient on demand or activated electronically such as by a timer. The switch can also be a passive switch such as one actuated by the opening of the pharmaceutical container. Such a switch can be activated by light such as a photosensitive resistor or photo-transistor. Such a switch can be also mechanically actuated where the opening and closing of the container depresses and releases a spring contact. The switch can be separate from the audio generator circuit or integrated therewith on a single chip.

Suitable electric power sources are those conventionally known in the art such as conventional batteries, solar cells, wall plug and transformer arrangements, or a magnetic, mechanical or RF re-energizing device.

The sound device can include those conventionally known in the art such as a speaker, an amplifier/speaker combination, a piezoelectric sound device or an amplifier/piezoelectric sound device combination. Conventional piezoelectric sound devices have limits on sound quality but are easier to produce in a small size.

The audio signal generating circuit can vary widely in design provided it contains programmable memory cells suitable for storing information relating to the dosage of the pharmaceutical in the container and/or other information. The audio signal generating circuit is activated by a switch and powered by the electric power source so as to provide a voltage which will cause the sound device to vibrate and generate sound waves. An alternative is for the audio signal generating circuit to generate a voltage which will operate a transmitter which sends a signal to a remote receiver for the operation of a remote sound device. Such a configuration is well suited for use in combination with a hand-held computer such as those sold under the trade names Palm® and Pilot®.

FIG. 8 illustrates an example of a micro-electronic device 60 of the present invention which comprises (a) power source 61, (b) switch 62 for actuation the micro-electronic device to transmit an audio signal, (c) audio generator circuit 63 with programmable memory cells 65 and (d) a sound device 64A which emits sound waves. Power source 61 is electrically coupled to audio generator circuit 63 to power the components therein and preferably those of the micro-electronic device attached thereto such as the sound device. Audio generator circuit 63 is activated by switch 62 to supply a voltage for vibration of a sound device such as a piezoelectric sound device 64A (shown) or a speaker (not shown). The voltage supplied is based on information stored in programmable memory cells 65. The programmable memory cells can include those conventionally known in the art such as erasable programmable read-only memory (EPROMS), random access memory (RAM) or non-volatile analog storage cells. Piezoelectric device 64A (or a speaker) vibrates in response to this voltage supplied by the audio generator circuit 63 to generate the sound waves. The piezoelectric sound device 64A is shown operatively connected at electrodes 66 to audio signal generating circuit 63 by leads 71 and 72. An alternative to using a speaker or piezoelectric sound device as the sound device is to use an RF transmitter, infra-red transmitter or a similar transmitter which can transmit information to a hand-held computer equipped with an amplifier and microphone or piezoelectric device to provide the necessary audio signal.

The audio generator circuit can be completely integrated on a single chip. Examples include model number UN-3166-8H available from UNC Corporation and those of the ISD 2500 series and ISD 1000 series manufactured by ISD Corporation located in San Jose, Calif. Similar devices are produced by Texas Instruments. As indicated above, in certain embodiments, the switch maybe integrated in the same chip as the audio generator circuit. Such chips only require a sound device and power source to complete the micro-electronic device. It is contemplated that a micro-electronic device with a power source and sound device integrated on the same chip as the audio circuit would also be suitable for this invention.

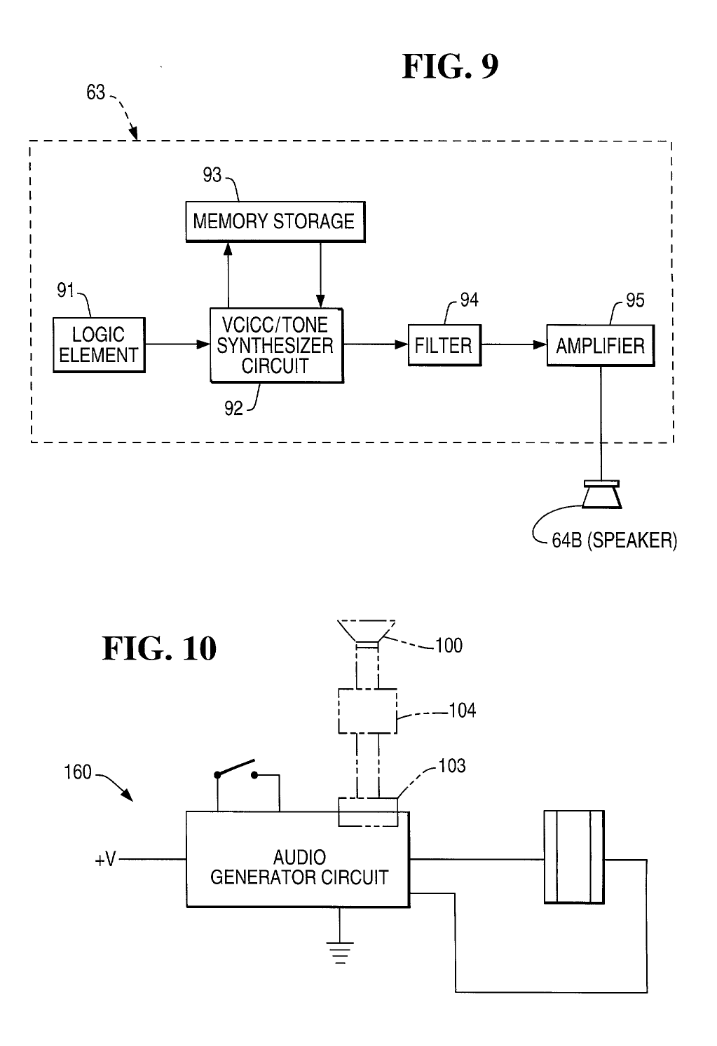

As illustrated in FIG. 9, the audio generator circuit 63 typically includes logic elements 91 which control the initiation and termination of the operation of a voice/tone synthesizer circuit 92. An example of a logic element is the on/off selector flip/flop described in U.S. Pat. No. 5,130,696. Another example of a logic element is a timer as described in U.S. Pat. No. 5,063,698. These circuits typically retrieve electrical signals stored in memory 93, typically ROM chips, and convert them to a voltage which, once amplified by amplifier 95, will vibrate a sound device such as speaker 64B (shown) or a piezoelectric sound device (not shown) to generate an audio signal. Optional filter 94 may be employed before amplification to reduce static and background noise.

The micro-electronic device contains programmable memory cells such as erasable programable read-only memory (EPROMS) which can be programmed from a host computer (central processing unit) by a) an RF signal from a peripheral device such as an RF transceiver or RF transmitter, b) infrared beams through an infrared window and infrared transceiver, or c) hard wiring to the central processing unit such as by electrical contacts connected directly through a port. Preferably the same central processing unit which prints the labels for the container is used to program the micro-electronic device and the memory cells are programmed simultaneously or contemporaneously with the printing of the label. The memory for storing audio information is also preferably addressable and segmentable so that two or more audio signals can be transmitted. They may be alternatively accessible through activation of the switch. In certain embodiments the memory cells can be interchanged with alternative programmable memory cells with distinct information stored therein.

Components which allow the micro-electronic devices to be programmed by RF frequencies or infrared beams are described in U.S. Pat. No. 5,640,002. In programming the micro-electronic device by hard wiring, a special port or a conventional port or card slot such as PCMCIA card slot, as described in U.S. Pat. No. 5,640,002, can be used. Specifications for PCMCIA cards and slots are known through publications by the PCMCIA Industry Association. To program the memory cells directly via bus contacts connected to the central processing unit, the entire micro-electronic device may be coupled to a port, or only a memory cell (ROM) or card may be programmed by coupling to a port, and the card or memory cell inserted into the micro-electronic device.

Included within this invention are containers comprising micro-electronic devices which are programmed prior to installation into the container and/or prior to printing of the label for said container. Such embodiments suffer from the disadvantage that it is necessary for the pharmacist to match the appropriate pre-programmed micro-electronic device or container which contains such a device with the pharmaceutical to be administered. Such a device with the correct dosage information will perform as well as a device programmed simultaneously or contemporaneously with the printing of the dosage label.

An alternative to programming the memory cells from a host computer (central processing unit), is to program the memory cells directly by voice communication as shown in FIG. 10. The micro-electronic device 160 can include a microphone 100, or can be connected to a remote microphone, which feeds audio information to the memory cells 103, typically after digital conversion via digital converter 104. This allows the pharmacist to record dosage information in the memory cells with his own voice. The pharmacist can also record audible tones such as those that will dial a certain telephone number.

In an advanced embodiment, the micro-electronic device may contain a timer to send an audio tone or voice alarm to the patient to take the pharmaceutical. Such a device will preferably have a passive switch activated by the opening of the container or removing medications therefrom that will interact with the timer so as to send an alarm only when the dosage is skipped or taken twice. Where a passive switch is used to generate the audio signal regarding dosage information, it can also be coupled to such a monitoring device within the container. In addition to an alarm, a message can be included on how to approach missed dosages or dosages taken too early or too late. Where the container includes a passive switch as part of monitoring device, it is desirable that the container have a mechanism for metering the dosage, as do the embodiments shown in FIGS. 5-7, such that overdoses and missed dosages can be monitored more accurately.

In a further advanced embodiment where the container includes a dose monitoring device, the micro-electronic device can include an RF transmitter or RF transceiver which can relay dosage information to a receiving device. This allows dosages to be monitored by medical personnel from a remote location. An example is a RF transceiver as described in U.S. Pat. No. 5,640,002, where the micro-electronic device communicates with a host computer via an RF link implemented by a spread spectrum radio transceiver incorporated in the host computer. The receiving station in the micro-electronic device receives characters and transmits them to the memory cells via a bus. A suitable RF transceiver is commercially available from Proxim Inc. located in Mount View, Calif. This RF transceiver acts like a modem in modulating digital data to an the RF carrier as audio tones. Alternative RF transceivers can provide voice communication such as the 900 MHZ RF transceiver available from Wireless Logic Inc. of San Jose, Calif. This 900 MHZ spread spectrum RF transceiver module utilizes a WLT 9009 speed spectrum signal processor integrated circuit to send either digital data, voice data or both to a receiving station on the micro-electronic device. For such a feature, the micro-electronic device includes an RF antennae for communication with the host computer.

The entire disclosure of all applications, patents and publications, cited above are hereby incorporated by reference.

From the foregoing description, one skilled in the art can easily ascertain the essential characteristics of this invention, and without departing from the spirit and scope thereof, can make various changes and modifications of the invention to adapt it to various usages and conditions.

What is claimed is:

1. A pharmaceutical container which generates at least one audio signal that contains information regarding the dosage of the pharmaceutical in said container.

2. A pharmaceutical container with a label that contains written dosage instructions which generates at least one audio signal that contains information consistent with or identical to the written dosage instructions on said label.

3. A container as in claim 1, wherein the audio signal provides verbal information selected from the group consisting of what the pharmaceutical is, who the patient is, when to take the medication, what to take the medication with, what not take the medication with, contra-indications, how to adjust for a missed dose, what to do if there is an overdose and combinations thereof.

4. A container as in claim 1 wherein the audio signal comprises voice information of at least 20 words or more.

5. A container as in claim 2 wherein the dosage information in the form of an audio signal is identical to the dosage information printed on the label, supplemental to the dosage information printed on the label or both identical and supplemental to the dosage information printed on the label.

6. A container as in claim 1 which additionally comprises a mechanism for monitoring the dosages of the pharmaceutical removed from said container.

7. A container as in claim 1 which additionally comprises a mechanism for metering the dosages of the pharmaceutical removed from said container.

8. A pharmaceutical container for a patient which comprises a micro-electronic device that transmits dosage information for a pharmaceutical in the form of an audio signal, said micro-electronic device comprising:
(a) a switch for activation of the micro-electronic device to transmit said audio signal;
(b) an audio signal generator circuit with programmable memory cells for storing information relating to the dosage of the pharmaceutical in the container, wherein said audio generator circuit is electrically connected and activated by said switch to supply a voltage, based on the information stored in the programmable memory cells, for the vibration of a sound device;
(c) a sound device which vibrates to generate sound waves in response to a voltage, which is operatively connected to said audio signal generator circuit; and
(d) at least one electric power source operatively connected to said audio signal generator circuit to power said audio signal generator circuit.

9. A container as in claim 8 wherein the switch is selected from light actuated switches and mechanically actuated switches, and the sound device comprises a power amplifier and piezoelectric sound device.

10. A container as in claim 8 wherein the information stored in the programmable memory includes information regarding the patient to whom the pharmaceutical within the container is administered.

11. A container as in claim 8 wherein the programmable memory cells can be interchanged with alternative programmable memory cells with distinct information.

12. A container as in claim 8 wherein the switch is a passive, light-sensitive switch which is actuated when the container is opened and closed.

13. A container as in claim 8 wherein the programmable memory stores two or more different audio signals relating to the dosage of the pharmaceutical in the container.

14. A container as in claim 13 wherein the two or more different audio signals are alternatively accessible through activation of said switch.

15. A container as in claim 8 which additionally contains a label with dosage information for the pharmaceutical within the container printed thereon, wherein the information within the programmable memory cells relating to the pharmaceutical within the container is stored either simultaneously or contemporaneously with the printing of the dosage information for said pharmaceutical on said label.

16. A container as in claim 8 wherein the information within the programmable memory cells relating to the pharmaceutical within the container is programmed either simultaneously or contemporaneously with the filling of the pharmaceutical container with said pharmaceutical.

17. A container as in claim 8 wherein the information within the programmable memory cells relating to the pharmaceutical within the container is programmed prior to filling the pharmaceutical container with said pharmaceutical.

18. A container as in claim 8 which additionally comprises a mechanism for monitoring the opening and closing of said container.

19. A container as in claim 8 which additionally comprises a mechanism for metering the dosages of pharmaceutical removed from said container.

20. A container as in claim 18 wherein the micro-electronic device additionally contains an RF transmitter for sending information regarding the monitored opening and closing of said container to a central processing unit.

21. A container as in claim 19 wherein the micro-electronic device additionally contains an RF transmitter for sending information regarding the metered dosages of pharmaceutical to a central processing unit.

22. A container as in claim 8 which is a bottle for pills, powders or liquids, wherein the micro-electronic device is incorporated in the cap, walls or bottom portion of said bottle.

23. A bottle as in claim 22 wherein the micro-electronic device is incorporated in the cap, walls or bottom portion of said bottle by adhesion thereto.

24. A pharmaceutical container for a patient which comprises a micro-electronic device that transmits dosage information for a pharmaceutical in the form of an audio signal, said micro-electronic device comprising:
(a) a switch for activation of the micro-electronic device to transmit said audio signal:,
(b) an audio signal generator circuit with programmable memory cells for storing information relating to the dosage of the pharmaceutical in the container, wherein said audio signal generator circuit is electrically connected and activated by said switch to supply a voltage, based on the information stored in the programmable memory cells, for the operation of a transmitter;
(c) a transmitter which transmits signals to a remote receiver for the operation of a sound device, said transmitter being operatively connected to said audio signal generator circuit; and
(d) at least one electric power source operatively connected to said audio signal generating circuit to power said audio signal generator circuit.

25. A pharmaceutical container for a patient which comprises:
A. a lid, alternatively positionable to an opened position and a closed position; and
B. a micro-electronic device that transmits dosage information for a pharmaceutical in the form of an audio signal, said micro-electronic device comprising:
(a) a switch for sensing when said lid is in an opened position or closed position which activates the micro-electronic device to transmit said audio signal when said lid is in an opened position;
(b) an audio signal generator circuit with programmable memory cells for storing information relating to the dosage of the pharmaceutical in the container, wherein said audio generator circuit is electrically connected and activated by said switch to supply a voltage, based on the information stored in the programmable memory cells, for the vibration of a sound device;
(c) a sound device which vibrates to generate sound waves in response to a voltage, which is operatively connected to said audio signal generator circuit; and
(d) at least one electric power source operatively connected to said audio signal generator circuit to power said audio signal generator circuit.

26. A container as in claim 25 wherein the programmable memory cells are interchangeable with other programmable memory cells with different information.

27. A container as in claim 26 which is a bottle for pills, powders or liquids, wherein the micro-electronic device is incorporated in the label, cap, walls or bottom portion of said bottle.

28. A bottle as in claim 27 wherein the micro-electronic device is incorporated in the label cap, walls or bottom portion of said bottle by adhesion thereto.
